(19) United States
(12) Patent Application Publication
(10) Pub. No.: US 2022/0136277 A1
(43) Pub. Date: May 5, 2022

(54) TENT SYSTEM

(71) Applicant: Damon Bungard, Spencer, TN (US)

(72) Inventor: Damon Bungard, Spencer, TN (US)

(21) Appl. No.: 17/514,473

(22) Filed: Oct. 29, 2021

Related U.S. Application Data
(60) Provisional application No. 63/107,777, filed on Oct. 30, 2020.

(51) Int. Cl. E04H 15/48; E04H 15/56

(52) U.S. Cl. CPC E04H 15/48; E04H 2015/326; E04H 15/56

(57) ABSTRACT

Various implementations include a tent system that includes a cover and base. The cover includes a cover frame and a canopy. The cover frame includes two or more cover frame members that are removably couplable to each other. The canopy is couplable to, and extendable between, the cover frame. The base includes three or more legs, a base frame, one or more base hubs, and a base support. The base frame includes two or more base frame members. The legs are removably couplable to the base hubs. Each of the base frame members are removably couplable to each other and/or to one or more base hubs. The base support is couplable to the base frame such that the base support is extendable between base frame members. The cover frame members are removably couplable to the base hubs such that a chamber is defined by the canopy and the base support.

### BACKGROUND

Current tent systems exist to shield the user from the elements of the outdoors. Many tents include at least one fabric layer supported by frame members that defines an interior of the tent. In some tents, the fabric layer includes a ground portion that lies on the ground and a cover portion that extends over the ground portion to define the interior of the tent. Current tent systems also often require a user to find a flat stretch of ground for stable tent pitching. Some of the components of these tent systems are designed to be interconnected for stability. For example, the cover portion is not erectable separately from the ground portion.

Current dog blind systems include raised supports to keep a dog off the ground and shield the dog from the outdoor elements. However, some current dog blind systems are difficult to transport and set up and do not include a cover that is erectable and stable separately from the raised support.

Thus, a need exists for a tent or dog blind that is easily transported and erectable and includes a cover portion and support portion that can be erected and used together or separately from each other.

### SUMMARY

Various implementations include a tent system. The system includes a cover and a base. The cover includes a cover frame and a canopy.

The cover frame includes two or more cover frame members. The two or more cover frame members are removably couplable to each other. The canopy is couplable to the cover frame such that the canopy is extendable between at least two cover frame members when the cover frame members are coupled to each other.

The base includes a base, three or more legs, one or more base hubs, and a base support. The base frame includes two or more base frame members. Each of the legs is removably couplable to one of the base hubs. Each of the base frame members are removably couplable to each other and/or to one or more base hubs. The base support is couplable to the base frame such that the base support is extendable between at least two base frame members when the base frame members are coupled to each other and/or to one or more base hubs.

At least one of the cover frame members is removably couplable to at least one base hub such that, when the base frame members and base hubs are coupled to each other and the cover frame members are coupled together, a chamber is defined by at least a portion of the canopy and at least a portion of the base support.

In some implementations, the cover is erectable independently of the base.

In some implementations, the base is erectable independently of the cover.

In some implementations, the cover frame members are hollow. In some implementations, the cover frame further includes a resilient member extending through two or more of the cover frame members.

In some implementations, the canopy is a fabric material.

In some implementations, the base support is a fabric material. In some implementations, the fabric material of the base support is porous.

In some implementations, each of the cover frame members has an end and at least one of the base hubs defines a primary base hub opening. The end of at least one of the cover frame members is removably disposable in the primary base hub opening. In some implementations, the system further includes at least one coupling strap configured to couple the at least one cover frame member to the at least one base hub when the end of the at least one cover frame member is disposed within the primary base hub opening.

In some implementations, each of the base frame members has an end and the end of at least one of the base frame members is coupled to at least one of the base hubs.

In some implementations, each of the base frame members has an end and at least one of the base hubs defines a secondary base hub opening. The end of at least one of the base frame members is removably disposable in the secondary base hub opening.

In some implementations, each of the base frame members has an end, and the end of at least one of the base frame members is coupled to the end of another base frame member.

In some implementations, the cover further comprises one or more cover hubs. Each of the cover frame members has an end and at least one of the cover hubs defines a primary cover hub opening. The end of at least one of the cover frame members is removably disposable in the primary cover hub opening. In some implementations, at least one of the cover hubs defines a secondary cover hub opening. The end of at least one of another cover frame members is removably disposable in the secondary cover hub opening.

In some implementations, the end of another cover frame member is coupled to at least one of the cover hubs.

In some implementations, each of the cover frame members has an end, and the end of at least one of the cover frame members is coupled to the end of another cover frame member.

In some implementations, the one or more base hubs include at least two base hubs. In some implementations, the one or more base hubs include at least four base hubs. In some implementations, the one or more base hubs include at least six base hubs.

In some implementations, the two or more cover frame members include at least three cover frame members. In some implementations, the two or more cover frame members include at least five cover frame members. In some implementations, the two or more cover frame members include at least thirteen cover frame members.

In some implementations, the base support is coupled to the base with one or more base straps.

In some implementations, the three or more legs include at least four legs. In some implementations, the three or more legs include at least eight legs.

In some implementations, each of the legs has an end and at least one of the base hubs defines a tertiary base hub opening. The end of at least one of the legs is removably disposable in the tertiary base hub opening. In some implementations, at least one of the base hubs defines a quaternary base hub opening. The end of at least one of the legs is removably disposable in the quaternary base hub opening.

### BRIEF DESCRIPTION OF DRAWINGS

Example features and implementations are disclosed in the accompanying drawings. However, the present disclosure is not limited to the precise arrangements and instrumentalities shown.

FIG. 1 is a perspective view of a tent system in accordance with one implementation.

FIG. 2 is a perspective view of the tent system of FIG. 1 with the canopy and base support removed.

FIG. 3 is a perspective view of the tent system of FIG. 1 with the canopy removed.

FIG. 4 is a perspective view of the cover of the tent system of FIG. 1.

FIG. 5 is a perspective view of a tent system in accordance with another implementation.

FIG. 6 is a detailed perspective view of a cover hub of FIG. 1.

FIG. 7 is a detailed perspective view of a cover hub and a cover frame member distantly coupled.

FIG. 8 is a detailed perspective view of a cover frame member distantly coupled to another cover frame member.

FIG. 9 is a perspective view of a base of the tent system of FIG. 1.

FIG. 10 is a detailed perspective view of the top of a base hub of FIG. 1.

FIG. 11 is a detailed perspective view of the bottom of the base hub of FIG. 10.

FIG. 12 is a detailed perspective view of a leg portion distantly coupled to another leg portion.

### DETAILED DESCRIPTION

The devices, systems, and methods disclosed herein provide for a tent system that includes a cover and a base. The cover and base can be coupled together to provide a raised support with a shelter. The cover and base of the tent system are each collapsible and erectable independently of each other. Thus, the cover can be used as a shelter independently of the base, and the base can be used as a raised support independently of the cover. In some implementations, the tent system is easy to pack, transport, and assemble/disassemble. The cover and base of the tent system can be configured to support and/or shelter a human being, a dog, any animal, or one or more objects.

The cover and base each include frame members and hubs. The hubs couple the frame members together. In addition, the base hubs of the base define openings in which the ends of some the cover frame members can be disposed to couple the cover to the base, forming a raised support with a shelter.

Various implementations include a tent system. The tent system includes a cover and a base. The cover includes a cover frame and a canopy. The cover frame includes two or more cover frame members. The two or more cover frame members are removably couplable to each other. The canopy is couplable to the cover frame such that the canopy is extendable between at least two cover frame members when the cover frame members are coupled to each other. The base includes three or more legs, a base frame, one or more base hubs, and a base support. The base frame includes two or more base frame members. Each of the legs is removably couplable to one of the base hubs. Each of the base frame members are removably couplable to each other and/or to one or more base hubs. The base support is couplable to the base frame such that the base support is extendable between at least two base frame members when the base frame members are coupled to each other and/or to one or more base hubs. At least one of the cover frame members is removably couplable to at least one base hub such that, when the base frame members and base hubs are coupled to each other and the cover frame members are coupled together, a chamber is defined by at least a portion of the canopy and at least a portion of the base support.

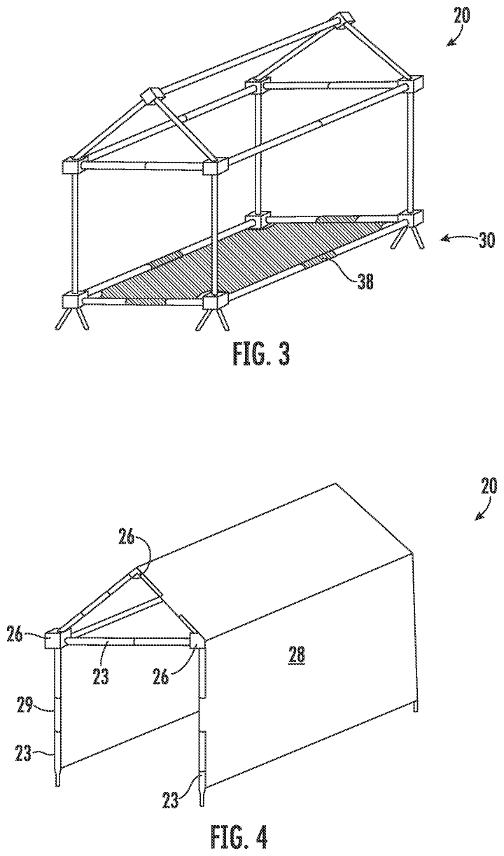

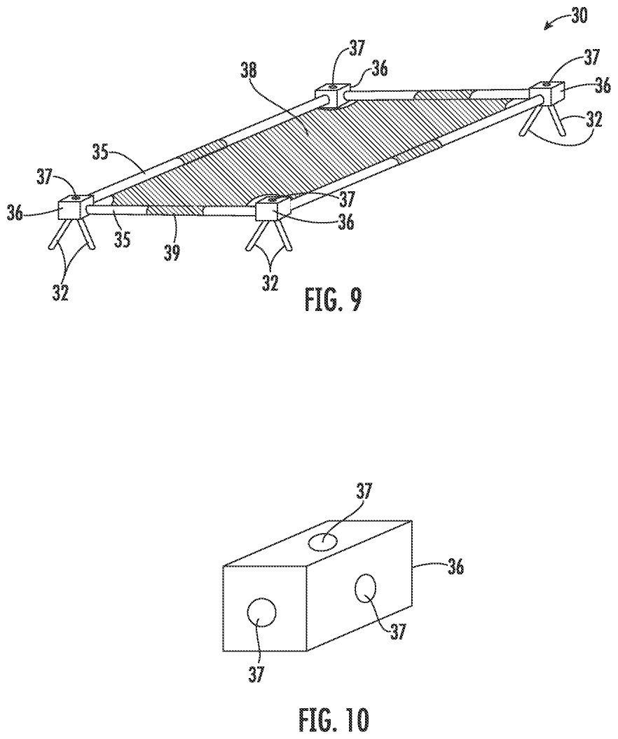

FIG. 1 shows a tent system 10 according to one implementation. The tent system 10 includes a cover 20 and a base 30. The cover 20 and base 30 are coupled together to define a chamber 40 therebetween. However, as shown in FIGS. 4 and 9, the cover 30 and the base 30 are also erectable and supportable independently of each other.

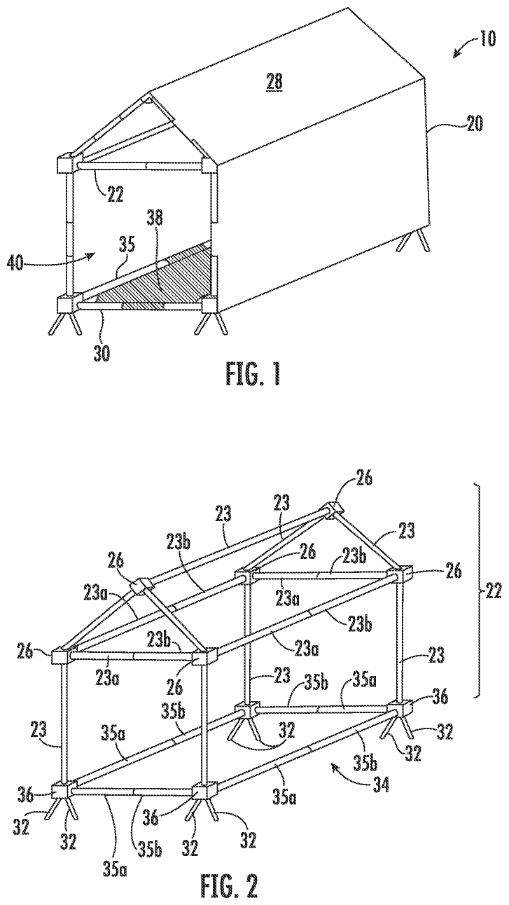

The cover 20 includes a cover frame 22 and a canopy 28 that extends over, and is couplable to, the cover frame 22 when assembled. FIG. 2 illustrates the cover frame 22 without the canopy 28. As shown, the cover frame 22 includes cover frame members 23 and cover hubs 26. The cover frame members 23 are removably couplable to each other using the cover hubs 26. The cover frame members 23 are hollow and cylindrical and are made of a relatively light weight and rigid material, such as aluminum or plastic. Each cover frame member 23 includes two ends that are opposite and spaced apart from each other along a longitudinal axis of the cover frame member 23. Each end of each cover frame members 23 is tapered relative to an intermediate portion of the cover frame member 23. The tapered ends are engageable with openings defined in the cover hubs 26, which is discussed below.

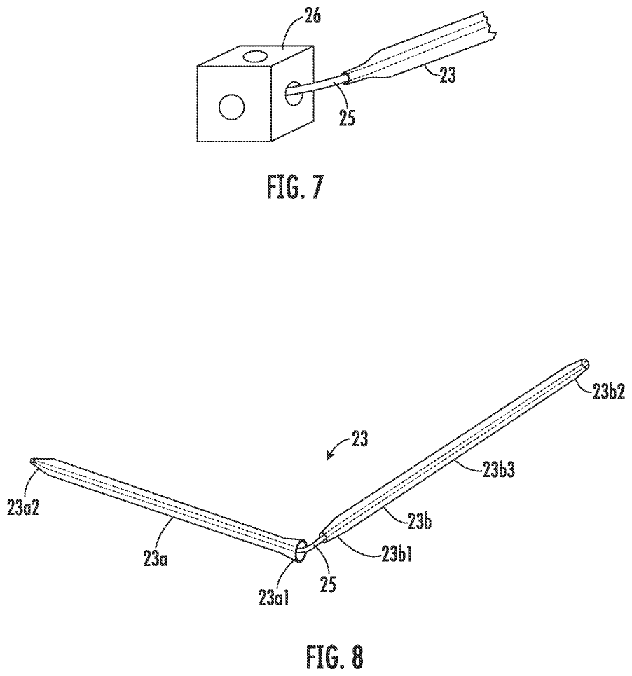

A portion of the cover frame members 23 includes a first portion 23a and a second portion 23b that are coupled together at facing ends of each portion 23a, 23b. The portions 23a, 23b can be removably engaged together by inserting a tapered end of one portion 23a, 23b into a receiving end of the other portion 23b, 23a. In the implementation shown in FIG. 8, each end of the cover frame member portion 23b includes tapered portions 23b1, 23b2 having a minimum outer diameter that is narrower than the outer diameter of an intermediate portion 23b3 of the cover frame member portion 23b. One end of the cover frame member portion 23a includes a receiving portion 23a1 having a maximum inner diameter that is larger than the minimum outer diameter of the tapered portion 23b1 for portion 23b and the other end includes a tapered portion 23a2 similar to the tapered portions for portion 23b. The tapered portion 23b1 of cover member portion 23b is insertable into the receiving portion 23a1 of cover frame member portion 23a to form an interference fit coupling the two cover frame member portions 23a, 23b to each other. A resilient member 25 extends between the portions 23a, 23b and couples the portions 23a, 23b together when the tapered portion 23b1 is not inserted into the receiving portion 23a1. FIG. 2 illustrates the portions 23a, 23b engaged to each other by an interference fit, and FIG. 8 illustrates the portions 23a, 23b not engaged(i.e., separated) such that the facing ends are spaced apart from each other but remain distantly coupled by resilient member 25.

The resilient members 25 in FIG. 1 are cylindrical bungee cords, but in other implementations, the resilient members are any elastically extendable material capable of distantly coupling the cover frame member portions when the ends of the cover frame members are separated.

FIG. 6 shows a detailed view of one of the cover hubs 26 of FIG. 1. Each cover hub 26 is a rectangular prism (e.g., a cube) and is made of a relatively light weight and rigid material, such as aluminum or plastic. Each cover hub 26 defines two or more cover hub openings 27. Each cover hub opening 27 has a circular cross section as viewed in a plane defined by the face of the cover hub 26 that defines the cover hub opening 27. The diameter of the cover hub opening 27 is larger than the minimum outer diameter of the tapered portions 23a2, 23b2 of the ends of the cover frame members 23 and smaller than the maximum outer diameter of the tapered portions 23a2, 23b2 of the ends of the cover frame members 23. Although some of the cover hub openings 27 extend perpendicular to the face of the cover hub 26 that defines the cover hub opening 27, some cover hub openings 27 extend transverse to the respective face of the cover hub 26 on which each opening is defined. For example, some of the cover hub openings 27 extend perpendicular to the respective face of cover hub 26, and some of the cover hub openings 27 extend at an angle of between 0 and 90 degrees from the respective face of the cover hub 26.

For example, as shown in FIG. 2, each of the cover hubs 26 along the apex of the cover frame 20 each include at least three openings 27 for coupling three cover frame members 23 together. The axis of each opening 27 is angled relative to the face that defines the opening to match the angle at which the cover frame members 23 are to be coupled to the cover hub 26 and each other. Each of the cover hubs 26 shown below the apex of the cover frame 20 have at least four openings 27 for coupling four cover frame members 23 together. The axis of each opening 27 is angled relative to the face that defines the opening to match the angle at which the cover frame members 23 are to be coupled to the cover hub 26 and each other. For example, a range of suitable angles of the axes of each opening relative to the face that defines the opening includes 30 to 120 degrees. In other implementations, the cover hub openings each extend in any angle necessary for a desired cover frame configuration.

As shown in FIGS. 1-5, the cover frame 22 of the tent system shown in FIG. 1 includes thirteen cover frame members 23 and six cover hubs 26. The tapered portions 23a2, 23b2 of the cover frame members 23 are insertable into the openings 27 of the cover hubs 26 to couple the cover frame members 23 together to define a three-dimensional structure. However, in other implementations, the cover includes any number of cover frame members and cover hubs.

As shown in FIG. 7, one or more of the cover frame members 23 are also coupled to the cover hubs 26 via a resilient member 25 that extends through the cover hub 26 and the cover frame members 23 that are removably engageable with the opening 27 of the respective cover hub 26. The resilient member 25 allows the cover frame members 23 to be removably disposed within the cover hub opening 27, forming an interference fit with the opening 27, but keeps the cover frame member 23 coupled with the intended cover hub 26 when the cover frame member 23 is removed from the opening 27. Because the cover frame members 23 remain distantly coupled to the resilient members 25 while not inserted within the openings 27 of the cover hub 26, the cover frame members 23 and cover hubs 26 remain organized when disassembled and can be easily assembled together during erection of the cover 20. However, in other implementations, the end of a cover frame member is insertable into the opening of the cover hub without a resilient member extending therethrough.

The cover frame members in FIG. 1 are engaged with at least one cover hub, but in other implementations, the cover frame members may not be coupled to a cover hub. For example, in such implementations, two or more of the cover frame members may instead be coupled together by other coupling mechanisms, such as a hook, strap, or resilient members, that allow for removable engagement.

The canopy 28 is couplable to the cover frame 22 such that the canopy 28 is extendable between at least two cover frame members 23 when the cover frame members 23 are coupled to each other. The canopy 28 shown in FIGS. 1, 4, and 5 includes nylon fabric. A plurality of loops 29 are coupled to the canopy 28 along areas of the canopy 28 that are to be coupled to the cover frame members 23. The loops 29 are spaced apart from each other adjacent the perimeter of the canopy and, optionally, along a central portion of the canopy 28 that forms the apex of the cover 20 when assembled. The cover frame members 23 extend through the loops 29 to secure the canopy 28 to the cover frame members 23.

At least one portion of each loop 29 is coupled to the canopy material. Each loop may be separately formed from the canopy 28 or integrally formed therewith. For example, one or more loops may be formed by a material that is separately formed from the canopy material and is coupled thereto. A portion of the loop material is coupled to the canopy material by a suitable coupling mechanism (e.g., by sewing, using adhesive, or coupling via snaps or hook and loop material). At least one end of the loop material is couplable to the other end or the canopy material by a suitable coupling mechanism, such as hook and loop material, snaps, or tying the unattached portions of the loop material. As another example of a separately formed loop, the loop may be formed by hook and loop material that is sewn or otherwise coupled to the canopy and is couplable together to form the loop around the cover frame members. As an example of an integrally formed loop, the canopy material may be cut such that protrusions extend from the edge of each perimeter to be coupled to the cover frame members. The free ends of the protrusions are sewn or otherwise coupled to fixed ends of the protrusions to define loops through which the cover frame members can extend.

Alternatively, the canopy is made from canvas, cotton, or any other material that is water resistant. In other implementations, the canopy is made up multiple fabric panels or any configuration of fabric that is capable of surrounding the cover frame.

Referring back to FIGS. 1-3, 5, and 9, the base 30 includes a base frame 34, three or more legs 32, and a base support 38. Each of the legs 32 and the base support 38 are removably couplable to the base frame 34. The cover frame 22 is couplable to the base frame 34 to define a chamber 40 between the canopy 28 and the base support 38, as shown in FIG. 1.

The base frame 34 is made up of two or more base frame members 35 and one or more base hubs 36. Each of the base frame members 35 are removably couplable to each other via one or more base hubs 36. The base frame members 35 and base hubs 36 shown in FIG. 1 are similar to the cover frame members 23 and cover hubs 26, respectively, shown in FIG. 1. In particular, each base frame member 35 includes two ends that are opposite and spaced apart from each other along an axis of the base frame member 35. Each end of each base frame members 35 is tapered relative to an intermediate portion of the base frame member 35. The tapered ends are insertable with openings defined in the base hubs 36.

A portion of the base frame members 35 includes a first portion 35a and a second portion 35b that are coupled together at facing ends of each portion 35a, 35b. The portions 35a, 35b can be removably engaged together by inserting a tapered end of one portion 35a, 35b into a receiving end of the other portion 35b, 35a. Similar to the implementation of the cover member shown in FIG. 8, each end of the base frame member portion 35b includes tapered portions 35b1, 35b2 having a minimum outer diameter that is narrower than the outer diameter of an intermediate portion 35b3 of the base frame member portion 35b. One end of the base frame member portion 35a includes a receiving portion 35a1 having a maximum inner diameter that is larger than the minimum outer diameter of the tapered portion 35b1 for portion 35b and the other end includes a tapered portion 35a2 similar to the tapered portions for portion 35b. The tapered portion 35b1 of base member portion 35b is insertable into the receiving portion 35a1 of base frame member portion 35a to form an interference fit coupling the two base frame member portions 35a, 35b to each other. A resilient member 25 extends between the portions 35a, 35b and couples the portions 35a, 35b together when the tapered portion 35b1 is not inserted into the receiving portion 35a1. FIG. 2 illustrates the portions 35a, 35b engaged to each other by an interference fit.

The resilient members 25 extending between the portions 35a, 35b are cylindrical bungee cords, but in other implementations, the resilient members are any elastically extendable material capable of distantly coupling the base frame member portions when the ends of the base frame members are separated.

FIG. 10 shows a detailed view of the top of one of the base hubs 36 of FIG. 1, and FIG. 11 shows a detailed view of the bottom of one of the base hubs 36 of FIG. 1. Each base hub 36 is a rectangular prism and is made of a relatively light weight and rigid material, such as aluminum or plastic. Each base hub 36 defines four or more base hub openings 37. Each base hub opening 37 has a circular cross section as viewed in a plane defined by the face of the base hub 36 that defines the base hub opening 37. The diameter of each base hub opening 37 is larger than the minimum outer diameter of the tapered portions 35a2, 35b2 of the ends of the base frame member 35 and the minimum outer diameter of the tapered portion of the end of a leg 32, similar to the cover frame member 23 and cover hub 26 shown in FIG. 7. Although some of the base hub openings 37 extend perpendicular to the face of the base hub 36 that defines the base hub opening 37, some base hub openings 37 extend transverse to the respective face of the base hub 36 on which each opening 37 is defined. For example, some of the base hub openings 37 extend perpendicular to the surface of the base hub 36 that defines the base hub opening 37, and some of the openings 37 extend at an angle of between 0 and 90 degrees from the respective face of the base hub 36.

For example, as shown in FIG. 2, each of the base hubs 36 include at least five base hub openings 37 for coupling a cover frame member 23, two base frame members 35, and two legs 32 together. The bottom surface of each of the base hubs 36 defines at least two openings 37 along the central axis of each leg 32 for coupling the two legs 32 to the base frame 34. The axis of each opening 37 is angled relative to the face that defines the opening to match the angle at which the legs 32 are to be coupled to the base hub 36 and the base frame 34. The rest of the base hub openings 37 are for coupling a cover frame member 23 and two base frame members 35 together. The axis of each opening 37 is angled relative to the face that defines the opening 37 to match the angle at which the cover frame member 23 and the base frame members 35 are to be coupled to the base hub 36 and each other. For example, a range of suitable angles of the axes of each base hub opening 37 relative to the face that defines the opening 37 includes 30 to 120 degrees. In other implementations, the base hub openings each extend in any angle necessary for a desired cover frame configuration.

Similar to the cover hub 26 shown in FIG. 7, one or more of the base frame members 35 are also coupled to the cover hubs 36 via resilient members 25 that extend through the base hub 36 and the base frame members 35 that are removably engageable with the respective openings 37 of the respective base hub 36. The resilient member 25 allows the base frame members 35 to be inserted within the base hub opening 37 during assembly, forming an interference fit with the opening 37, but keeps the base frame member 35 coupled with the intended base hub 36 when the base frame member 35 is removed from the opening 37. Because the base frame members 35 remain coupled to the resilient members 25 while not inserted within the openings 37 of the base hub 36, the base frame members 35 and base hubs 36 remain organized when disassembled and can be easily assembled together during erection of the base 30. However, in other implementations, the end of a base frame member is insertable into the opening of the base hub without a resilient member extending therethrough.

As shown in FIGS. 1-3, 5, and 9, the base frame 34 of the tent system 10 includes four base frame members 35 and four base hubs 36. The tapered ends of the base frame members 35 are insertable into the openings 37 of the base hubs 36 to couple the base frame members 35 together to define a perimeter of the base 30. In addition, the cover 20 is coupled to the base 30 by inserting tapered ends of the vertically extending cover frame members 23 into corresponding openings of the base hubs 36.

The base support 38 includes ballistic nylon fabric that that has straps 39 with hook and loop closures. The base support 38 is shown in FIGS. 1 and 9. The base support 38 is couplable to the base frame 34 such that the base support 38 is extendable between at least two base frame members 35 when the base frame members 35 are coupled to each other and/or the base hubs 36. The straps 39 each wrap around a base frame member 35, and the hook and loop closures secure the straps 39 onto the base frame members 35.

The base support 38 shown in FIG. 1 is coupled to the base frame 35 with four straps and hook and loop, but in other implementations, the base support 38 is coupled to the base frame members 35 via any suitable removable coupling mechanism. For example, the base support 38 may be coupled to the base frame 35 via loops coupled to the perimeter of the base support through which the base frame members 35 extend. The loops may be formed from the same material as the base support and be integrally formed with the base support (e.g., as tabs of the base support material having distal ends that are sewn or otherwise coupled to the base support material to form a loop) or separately formed and coupled to the base support. Or, the loops may be made of another suitable material for securing the base support to the base frame members, considering the tension of the base support in use and the expected weight of the expected user of the base support.

Although the base support of the tent system shown in FIG. 1 includes ballistic nylon fabric, in other implementations, the base support is made from any mesh, nylon weave, or porous material that allows water to drain off and is strong enough to hold up the intended user.

The legs 32 of FIG. 1 are hollow, plastic, and cylindrical. Each leg 32 includes two ends. Some of the ends of the legs 32 include a tapered portion having an outer diameter that is narrower than the outer diameter of the rest of the leg 32 and the diameter of the base hub openings 37. A resilient member 25 extends between and is coupled to each leg 32 and the corresponding base hub 36 into which the leg 32 is engaged when the base 30 is assembled. The tapered portions of the end of one of the legs 32 is insertable into the base hub opening 37 at an angle. The other end of each leg 32 contacts the ground.

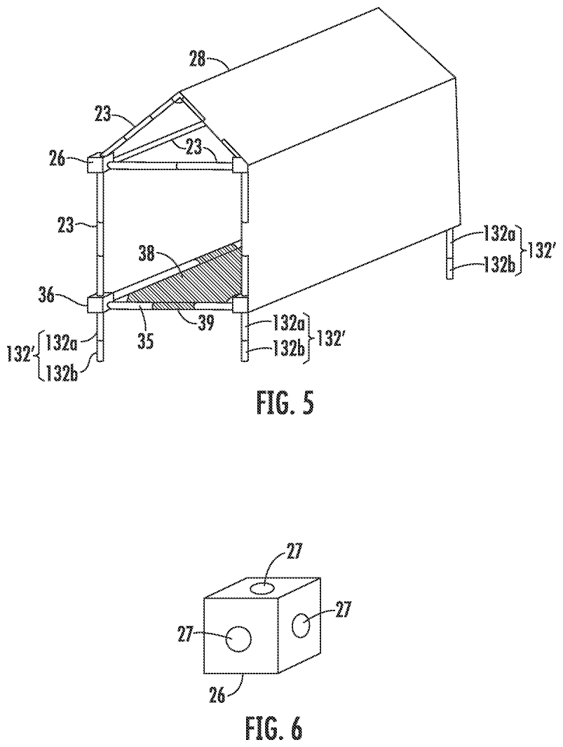

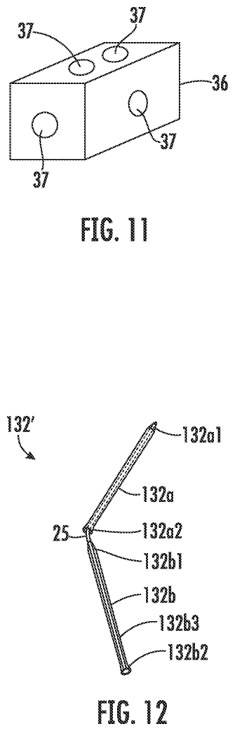

In an alternative implementation shown in FIG. 5, each leg 132 includes two leg portions 132a, 132b that are removably coupled to each other. The first portion 132a and a second portion 132b are coupled together at facing ends of each portion 132a, 132b. The portions 132a, 132b can be removably engaged together by inserting a tapered end of one portion 132a, 132b into a receiving end of the other portion 132b, 132a. In the implementation shown in FIG. 12, one end of the leg portion 132b includes a tapered portion 132b1 having a minimum outer diameter that is narrower than the outer diameter of an intermediate portion 132b3 of the leg portion 132b. One end of the leg portion 132a includes a receiving portion 132a2 having a maximum inner diameter that is larger than the minimum outer diameter of the tapered portion 132b1 for portion 132b and the other end includes a tapered portion 132a1 similar to the tapered portions for portion 132b. The tapered portion 132b1 of leg portion 132b is insertable into the receiving portion 132a2 of leg portion 132a to form an interference fit coupling the leg portions 132a, 132b to each other. A resilient member 125 extends between the portions 132a, 132b and couples the portions 132a, 132b together when the tapered portion 132b1 is not inserted into the receiving portion 132a1. FIG. 5 illustrates the portions 132a, 132b engaged together in the interference fit, and FIG. 12 illustrates the portions 132a, 132b not engaged (i.e., separated) such that the facing ends are spaced apart from each other but remain distantly coupled by resilient member 125.

Although the legs of FIG. 1 are hollow and cylindrical, in other implementations, the legs may be solid and/or any prismatic shape. In implementations in which the legs are solid, the legs are not distantly coupled by resilient members. Although the legs described above are made of plastic, in other implementations, they can be made of any rigid material such as aluminum or steel or any material strong enough to support the tent system and user. In other implementations, both of the ends of the legs are tapered, or both of the ends of the legs are receiving portions. In other implementations, some of the ends are tapered, and some of the ends are receiving portions.

As shown in the tent system 10 shown in FIG. 1, four of the cover frame members 23 are inserted into openings 37 of the base hubs 36, and a chamber 40 is defined by at least a portion of the canopy 24 and at least a portion of the base support 38. The four cover frame members 23 in FIG. 1 are removably engaged with the base hubs 36 with an interference fit, but in other implementations, a strap is configured to further couple the cover frame members to the base hubs while the cover frame members are disposed in the base hub opening.

The chamber 40 is configured to protect the intended user from the outdoor elements and to keep the user off the ground. The intended user of the tent system 10 can be a human, a dog, any animal, or one or more objects. The size and shape of the cover and base of the tent system 10 are configured depending on the intended user. The base and cover may further comprise a carrying loop to facilitate transport of the tent system.

In FIG. 1, the cover and base frame members are cylindrically shaped, hollow, are coupled by resilient members, and are made from a rigid plastic. However, in other implementations, the cover and base frame members are solid, have any suitable prismatic shape, are not coupled by resilient members, and/or are made out of any rigid material such as aluminum or steel.

In alternative implementations, the cover hubs and/or the base hubs define two or more hub openings. And, although the cover hub openings and base hub openings of FIG. 1 have circular cross-sections, in other implementations, the cover hub openings and/or the base hub openings can have any cross-sectional shape corresponding to a shape of the radial cross section of the end of the frame member intended to engage the respective opening.

In FIG. 1, the cover hubs and base hubs are made of plastic, but in other implementations, the cover hubs and/or base hubs are made of metal, wood, or any suitably rigid material for supporting the end of a cover frame member and/or base frame member when assembled.

In FIG. 1, the cover hub and base hub are shaped as rectangular prisms but in other implementations, the cover hub and/or base hub can be shaped as a sphere, an ovoid, a cylinder, a triangular prism, or any suitable three-dimensional shape.

The cover hubs and/or base hubs of FIG. 1 have resilient members anchored internally thereto, but in other implementations, the cover hubs and/or base hubs do not have resilient members anchored internally.

In FIG. 1, the cover frame members and/or base frame members are coupled to each other and/or to the cover hubs and/or base hubs by an interference fit, but in other implementations, the frame members and hubs may be coupled by interlocking threads, fittings, or any other coupling feature capable of supporting the assembled cover and/or support and allowing for removable engagement with the hubs.

In FIG. 1 the cover and base frame members are removably coupled to the cover and/or base hubs, but in other implementations, one or more cover frame members and/or base frame members are permanently coupled to the cover hubs and/or base hubs.

A number of implementations have been described. Nevertheless, it will be understood that various modifications may be made without departing from the spirit and scope of the claims. Accordingly, other implementations are within the scope of the following claims.

Certain terminology is used herein for convenience only and is not to be taken as a limitation on the present claims. In the drawings, the same reference numbers are employed for designating the same elements throughout the several figures. A number of examples are provided, nevertheless, it will be understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

1. A tent system, the system comprising:
a cover comprising:
a cover frame including two or more cover frame members, wherein the two or more cover frame members are removably couplable to each other, and
a canopy couplable to the cover frame such that the canopy is extendable between at least two cover frame members when the cover frame members are coupled to each other; and
a base comprising:
a base frame including two or more base frame members,
three or more legs,
one or more base hubs, wherein each of the legs is removably couplable to one of the base hubs, and wherein each of the base frame members are removably couplable to each other and/or to one or more base hubs, and
a base support couplable to the base frame such that the base support is extendable between at least two base frame members when the base frame members are coupled to each other and/or to one or more base hubs,
wherein at least one of the cover frame members is removably couplable to at least one base hub such that, when the base frame members and base hubs are coupled to each other and the cover frame members are coupled together, a chamber is defined by at least a portion of the canopy and at least a portion of the base support.

2. The system of claim 1, wherein the cover is erectable independently of the base.

3. The system of claim 1, wherein the base is erectable independently of the cover.

4. The system of claim 1, wherein the cover frame members are hollow.

5. The system of claim 4, wherein the cover frame further comprises a resilient member extending through two or more of the cover frame members.

6. The system of claim 1, wherein the canopy is a fabric material.

7. The system of claim 1, wherein the base support is a fabric material.

8. The system of claim 7, wherein the fabric material of the base support is porous.

9. The system of claim 1, wherein each of the cover frame members has an end and at least one of the base hubs defines a primary base hub opening, wherein the end of at least one of the cover frame members is removably disposable in the primary base hub opening.

10. The system of claim 9, further comprising at least one coupling strap configured to couple the at least one cover frame member to the at least one base hub when the end of the at least one cover frame member is disposed within the primary base hub opening.

11. The system of claim 1, wherein each of the base frame members has an end and the end of at least one of the base frame members is coupled to at least one of the base hubs.

12. The system of claim 1, wherein each of the base frame members has an end and at least one of the base hubs defines a secondary base hub opening, wherein the end of at least one of the base frame members is removably disposable in the secondary base hub opening.

13. The system of claim 1, wherein each of the base frame members has an end, and the end of at least one of the base frame members is coupled to the end of another base frame member.

14. The system of claim 1, wherein the cover further comprises one or more cover hubs, wherein each of the cover frame members has an end and at least one of the cover hubs defines a primary cover hub opening, wherein the end of at least one of the cover frame members is removably disposable in the primary cover hub opening.

15. The system of claim 1, wherein the end of another cover frame member is coupled to at least one of the cover hubs.

16. The system of claim 14, wherein at least one of the cover hubs defines a secondary cover hub opening, wherein the end of at least one of another cover frame members is removably disposable in the secondary cover hub opening.

17. The system of claim 1, wherein each of the cover frame members has an end, and the end of at least one of the cover frame members is coupled to the end of another cover frame member.

18.-23. (canceled)

24. The system of claim 1, wherein the base support is coupled to the base with one or more base straps.

25. (canceled)

26. (canceled)

27. The system of claim 12, wherein each of the legs has an end and at least one of the base hubs defines a tertiary base hub opening, wherein the end of at least one of the legs is removably disposable in the tertiary base hub opening.

28. The system of claim 27, wherein at least one of the base hubs defines a quaternary base hub opening, wherein the end of at least one of the legs is removably disposable in the quaternary base hub opening.
